(19) United States
(12) Patent Application Publication
(10) Pub. No.: US 2026/0213692 A1
(43) Pub. Date: Jul. 23, 2026

(54) DUAL INVERTER INTEGRATED CHARGER WITH SYNCHRONOUS MOTORS HAVING OPEN-END WINDING CONFIGURATION

(71) Applicant: Jacobi Motors, Inc., Missouri City, TX (US)

(72) Inventor: Ahmed Salah Morsy, Sugar Land, TX (US)

(73) Assignee: Jacobi Motors, Inc., Missouri City, TX (US)

(21) Appl. No.: 19/454,503

(22) Filed: Jan. 21, 2026

Related U.S. Application Data
(60) Provisional application No. 63/748,146, filed on Jan. 22, 2025.

(51) Int. Cl. H02P 29/50; B60L 53/22; H02J 7/00; H02J 7/02; H02P 25/28

(52) U.S. Cl. CPC H02P 29/50; B60L 53/22; H02J 7/02; H02J 7/855; H02J 7/865; H02P 25/28; B60L 2210/30

(57) ABSTRACT

The present disclosure relates to an integrated charger unit that utilizes variable flux memory motors (VFMMs) with an open-end winding configuration and a dual inverter setup comprising a first inverter and a second inverter. The charger improves performance of the VFMMs by applying higher winding voltage through use of multiple inverters. The VFMMs are operable in both driving and charging modes without requiring high-current switches, reducing system size, cost, and complexity. In the charging mode, windings of the VFMMs serve as filter inductors to smooth AC-to-DC conversion, facilitating battery charging via the first inverter. The charger unit is fault-tolerant, cost-efficient, and eliminates the need for a separate onboard charger, leveraging the bidirectional nature of the dual inverters for efficient energy utilization.

### CROSS-REFERENCE TO RELATED APPLICATIONS

This application claims priority, pursuant to 35 U.S.C. § 119(e), to U.S. Provisional Application No. 63/748,146 entitled, “DUAL INVERTER INTEGRATED CHARGER WITH SYNCHRONOUS MOTORS HAVING OPEN-END WINDING CONFIGURATION,” filed on Jan. 22, 2025. The contents of which are hereby incorporated by reference in its entirety.

### BACKGROUND

The present disclosure generally relates to synchronous electric motors and more particularly a dual integrated inverter configured with synchronous electric motors.

Synchronous electric motors, such as Variable Flux Memory Motors (VFMM) and Wound Field Synchronous Motors, are widely used in various industrial, commercial, and residential applications, such as including, but not limited to, fans, pumps, compressors, elevators, refrigerators, industrial machinery, electric motor vehicles, and the like. Synchronous motors are highly efficient, require low maintenance, and are capable of delivering high torque, making them suitable for diverse applications. Additionally, the use of permanent magnets in place of rotor windings reduces cooling requirements in such types of motors, further enhancing efficiency and reliability.

Electric vehicle applications, or generally other battery-powered applications, rely on rechargeable batteries as their primary energy source. These batteries may be charged periodically from external power sources, typically available as single-phase or three-phase alternating current (AC) at charging stations. Since batteries operate on direct current (DC), rectifiers may be employed to convert AC power into DC. To smooth out current variations during this conversion, external filter inductors may often be used. However, the inclusion of such inductors may increase weight, cost, and complexity of the charging system, while also introducing potential points of failure.

To avoid the need for external inductors, some solutions have explored using the motor windings themselves as filtering elements during charging. However, this approach may introduces significant challenges, especially in single inverter configurations. In a single inverter setup, the motor windings may be connected in traditional star or delta configurations. These configurations appear to have inherent limitations. For instance, the star or delta connection may restricts the voltage that maybe applied across the windings, reducing the power output and operational range. Also, during charging, the application of three-phase currents through the motor windings may generate undesirable torque.

Further, in permanent magnet motors, charging currents may demagnetize the rotor magnets, causing a gradual decline in motor performance over time (considering the rotor magnets cannot be re-magnetized). The inductance of the motor windings in a single inverter setup may be insufficient to effectively filter current variations, resulting in high current ripples and reduced charging efficiency. Single inverter configurations may also suffer from a lack of fault tolerance and operational flexibility. These systems may be less adaptable to varying power sources, such as single-phase and three-phase AC, and may not easily accommodate the diverse operational demands of charging and motor drive modes.

Furthermore, in single-phase charging scenarios, motors may generate a pulsating magnetic field instead of the rotating field seen in three-phase excitation. While this avoids torque generation, single-phase AC/DC conversion may introduce power ripples at twice the line frequency. To smooth out these ripples and ensure steady power flow to the battery, additional power decoupling mechanisms may be required. Existing decoupling solutions often involve additional electronic components such as filter inductors, power conducting switches, and the like, which increase the overall system cost, weight, and complexity.

Also, existing solutions may not allow the synchronous motors to be adapted for operation in multiple modes (such as charging and driving modes). Such switches may need to be capable of handling full motor current with which the integrated charger must operate, which increase the size, cost, and losses associated with the solution.

### SUMMARY

There is a utilitarian need for an integrated charger that may address the limitations of chargers with single inverter configurations, including voltage constraints, torque generation during charging, rotor demagnetization, and current ripple issues. Further, there is a need for an integrated charger that may also ensure efficient operation during charging and driving, support both single-phase and three-phase power sources, while reducing the overall size, weight, and cost of the system.

In one of a number of embodiments, a vehicle is disclosed having an Integrated Power Electronics Unit (“IPEU”) with a battery for storing power from a power source. The IPEU includes one or more synchronous motor having at least two phase windings in Open End Winding configuration, where each winding has at a first and a second end. The IPEU further includes at least a first and a second inverter, wherein the first inverter operably couples with the first end of each of the at least two phase windings, and operably configures bidirectional power flow between the battery and the at least one synchronous motor. The IPEU's second inverter is coupled with the second end of each of the at least phase windings and the power source. Further, the synchronous motor is operably configured as a filter inductor between the power source and the first inverter in a charging mode.

In other embodiments, the vehicle's IPEU has at least a charging mode and a driving mode. In the charging mode, the at least one synchronous motor is operably configured to allow power to flow between the power source and the battery, and in the driving mode, the battery is operably configured to allow power to flow to the at least one synchronous motor.

In other embodiments, the synchronous motor is operably configured to generate torque on corresponding with at least one voltage from the second inverter in a driving mode.

In other embodiments, the voltage comprises a winding voltage from the first inverter and the second inverter.

In yet other embodiments, the second inverter modulates the voltage across the at least two phase windings of the at least one synchronous motor.

In still yet other embodiments, the IPEU operably shifts between charging mode and driving mode according to a magnetization state of the synchronous motor.

In other embodiments, the second inverter provides a winding voltage corresponding with a magnetization state of the driving mode.

In yet other embodiments, the synchronous motor includes at least one rotor magnet having a magnetization adjusted by passing a pulse to magnetized or de-magnetized the at least rotor magnet.

In still other embodiments, the synchronous motor includes at least one soft-ferromagnetic material, and a magnetization state of the at least soft ferromagnetic material adjustable by a pulse of electric current to enable dynamic torque control.

In yet other embodiments, the at least one synchronous motor includes a Variable Flux Memory Motor (VFMM) or a Wound Field Synchronous Motor (“WFSM”).

In other embodiments, a step-down transformer is also incorporated to operably lower the power flow to the battery.

In another of a number of embodiments, an Integrated Power Electronics Unit (“IPEU”) is disclosed having a battery for storing power from a power source. The IPEU includes at least one VFMM having at least two phase windings in Open End Winding configuration, where each winding has at a first and a second end. The IPEU also includes at least a first and a second inverter. The first inverter is coupled with the first end of each of the two phase windings, and configured to allow bidirectional power flow between the battery and the at least one VFMM. The second inverter is coupled with the second end of phase windings and the power source. Further, the VFMM is configured as a filter inductor between the power source and the first inverter in a charging mode. Moreover, the the IPEU comprises at least a charging mode and a driving mode such that in the charging mode, the at least one VFMM is operably configured to allow power to flow between the power source and the battery, while in the driving mode, the battery is operably configured to allow power to flow to the at least one VFMM.

In other embodiments, the VFMM is configured to generate torque on corresponding with at least one voltage from the second inverter in a driving mode.

In yet other embodiments, the at least one voltage comprises a winding voltage from the first inverter and the second inverter.

In still yet other embodiments, the second inverter modulates the at least one voltage across the two phase windings of the VFMM.

In other embodiments, the electrical connections between the second end and the power source are operably activated and electrical connections between the second end and the second inverter are operably deactivated in the charging mode.

In yet other embodiments, the VFMM includes at least one rotor magnet having a magnetization operably adjusted by passing a pulse to magnetized or de-magnetized the at least rotor magnet.

In other embodiments, the first inverter is configured to convert at least one of a single-phase or three-phase alternating current (AC) from the power source into direct current (DC) to charge the battery.

In yet other embodiments, the IPEU also incudes an electromagnetic interference (EMI) filter positioned between the power source and the VFMM, where the EMI filter is configured to reduce electrical noise in the integrated charging and driving unit in the charging mode.

In still yet other embodiments, the battery is operably configured to store electric power from the power source during the charging mode, and supply electric power to the at least one synchronous motor through the first and second inverters during the driving mode.

In further still other embodiments, the second inverter is configured to supplement winding voltage provided to the at least one VFMM during the driving mode.

### BRIEF DESCRIPTION OF THE DRAWINGS

FIG. 1 shows a block diagram of an integrated synchronous motor power electronics unit implemented in a vehicle, according to one or more embodiments.

FIG. 2A shows a circuit diagram of the integrated synchronous motor power electronics unit in a driving mode, according to one or more embodiments.

FIG. 2B shows a circuit diagram of the integrated synchronous motor power electronics unit in a charging mode, according to one or more embodiments.

### DETAILED DESCRIPTION

Embodiments of the instant patent application are described in detail with reference to the accompanying figures. Like elements in the various figures are denoted by like reference numerals for consistency.

In the following detailed description, numerous specific details are set forth to provide a thorough understanding of the embodiments of the instant application. However, it would have been apparent to one of ordinary skill in the art that the disclosure may be practiced without some of these specific details. In other instances, well-known features have not been described in detail to avoid unnecessarily complicating the description.

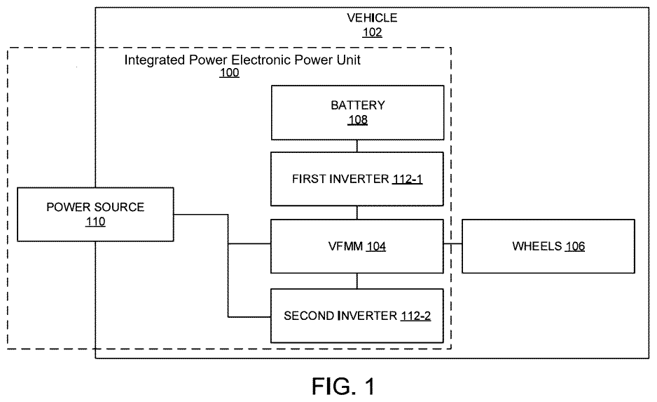

Referring to FIG. 1, a block diagram of an integrated synchronous motor power electronics unit (100) implemented in a vehicle (102) is illustrated. For the purposes of the present disclosure, integrated power electronics unit (100) may be realized by an integrated charger unit and/or an integrated driver unit. As shown, unit (100) may include one or more synchronous motors, such as variable flux memory motors (VFMMs) (104), each being connected to a corresponding mechanical load, such as a set of wheels (106) of the vehicle (102). In one or more embodiments, the VFMMs (104) may have an open-end winding (OEW) configuration. The VFMMs (104) may be configured to convert electrical energy to mechanical energy (such as rotational energy), and/or vice-versa. In some configurations, the VFMMs (104) may be configured to propel the vehicle (102) by turning the wheels (106), either directly or through a gear train or drivetrain. Further, the integrated unit (100) may include a battery (108) that stores electric power received from a power source (110). While the present disclosure is described in the context of the integrated unit (100) being adapted for automotive implementations, it may be appreciated by those skilled in the art that unit (100) may also be suitably adapted for other non-automotive applications as well, such as industrial applications, robotics, pumps (such as in water supply systems), renewable energy systems, and the like. Further, while the present disclosure is described in the context of the synchronous motors being VFMMs, embodiments of the present disclosure may be suitably adapted for use in other synchronous motors, such as a wound field synchronous motor (WFSM).

In one or more embodiments, the vehicle (102) may include, but not be limited to, electric vehicles, hybrid vehicles, and the like. Examples of the vehicle (102) include, but are not limited to, two-wheelers, three-wheelers, powered cycles, cars, vans, trucks, buses, hydraulic vehicles, electric trains, locomotives, boats, ships, and the like. The vehicle (102) may include one or more components configured to provide one or more functionalities. In some embodiments, the components may be selected from a group including, but not limited to, an e-drive motor, starters of a combustion engine, a thermal heater, e-axles, inverters, exhaust pipes, batteries, chargers, compressors, variable frequency drive, and fuel cells associated with the vehicle (102), which may be driven by the VFMMs (104). In some embodiments, the components may be powered by electricity. It may be appreciated that unit (100) may be implemented in any electrical system that requires a motor.

As stated, in one or more embodiments, the unit (100) may include multiple synchronous motors, such as the VFMMs (104), and one or more corresponding inverters/inverter modules (112-1 and 112-2). In some embodiments, the VFMMs (104) may be indicative of synchronous electric motors whose flux linkage (λm) may be dynamically and operably adjusted. The VFMMs (104) may be a type of synchronous motor where the magnetization of rotor magnets may be adjusted (e.g., changed) during operation. The adjustment of the magnetization of the rotor magnets may be referred to as “VFMM magnetization” or “magnetization state,” which allows for dynamic control of torque generated by the VFMMs (104) when electric power is supplied.

According to one or more embodiments, to facilitate changes in the magnetization state of the VFMMs (104), the rotor magnets may be made of soft-ferromagnetic materials, such as aluminum nickel cobalt (AlNiCo) or specific ceramics. These materials, also referred to as “soft magnets.” The soft magnets may be low coercive force (“LCF”) magnets that produce magnetomotive forces (“mmf”) when magnetized, allowing the soft magnets to be magnetized and demagnetized efficiently. In one or more embodiments, the soft magnets may be made of AlNiCo with grades 1-9 or similar materials, such as AlNiCo, cast, ceramics, some grades of samarium cobalt, or sintered construction of these materials. It may be apparent to those skilled in the art that specific amounts of these materials may be used to achieve a desired function of the VFMMs (104). The design, construction, number, and arrangements of a stator, the rotor, and the soft magnets of the VFMMs (104) may be suitably adapted based on requirements of the use cases.

In one or more embodiments, the magnetization states of the soft magnets may be changed to any value from about 0% magnetization (i.e., the soft magnets are completely demagnetized) to about 100% magnetization (i.e., the soft magnets are magnetized to their maximum capacity). The change in the magnetization states may occur in a short time span, i.e., in about 1 millisecond. In one or more embodiments, the magnetization states of the VFMMs (104) may be changed by passing a pulse of current therethrough such that the soft magnets are magnetized or de-magnetized up to a desired level. The level of magnetization of the soft magnets may be adjusted by controlling amplitude of the pulse of current. In some embodiments, the pulse of current may be provided to the soft magnets by the battery (108) through a set of commutators. In some embodiments, the inverter modules (112-1 and 112-2) may be connected to a corresponding inverter controller (not shown) that may be configured to adjust the pulse to shift the magnetization state of the soft magnets. In some embodiments, the pulse of current from the battery (108) may be modified or channeled through the inverter modules (112).

By suitably adjusting the magnetization states of the VFMMs (104), unit (100) may be operably shifted between a charging mode and a driving mode. In some embodiments, the VFMMs (104) may allow electric power to flow between the power source (110) and the battery (108) in the charging mode. In such embodiments, the soft magnets may be demagnetized to prevent torque from being generated by the VFMMs (106) when the electric power is supplied therethrough. Further, in the driving mode, unit (100) may be configured to supply electric power from the battery (108) to the VFMM (106)—or to another load/component of the vehicle (102). In such embodiments, the soft magnets may be re-magnetized to allow the VFMMs (106) to be energized, and enable the VFMMs (106) to generate torque. In embodiments where the synchronous motors are indicative of WFSM, a stator and a rotor thereof may be magnetically coupled in the driving mode. The intensity of magnetic fields of the rotor, and correspondingly the magnetic coupling between the stator and the rotor, may be manipulated by controllably varying electric current passed through the rotor.

In one or more embodiments, the VFMMs (104) may include one or more coils wound on the stator. The one or more coils on the stator may correspond to the phase windings of the VFMMs (104). In embodiments where the soft magnets are demagnetized, the coils associated with the stator may provide inductive reactance to the electric power supplied thereto. Since the soft magnets are demagnetized, the VFMMs (104) may be prevented from generating torque or excessive losses when excited by the electric power from the power source (110). In some embodiments, the soft magnets may be demagnetized by passing the pulse of current through the coils associated with the stator. In such embodiments, the VFMMs (104) may operate as a filter inductor when receiving power from the power source (110), thereby reducing the current ripples due to switching of the inverters (112-1, 112-2).

In one or more embodiments, the VFMMs (104) may have a set of phase windings in an OEW winding configuration. In some embodiments, the set of phase windings may correspond to the coils on the stator of the VFMMs (104). In some embodiments, each of the phase windings may have a first end and a second end that are open.

The VFMMs (104) may be in OEW configuration that allows the VFMMs (104) to be connected between two different components—such as two
inverters (112-1, 112-2) and/or the power source (110)—and ensure efficient operation without introducing unnecessary mechanical stresses or losses. The OEW configuration of the VFMMs may also allow for better utilization of the motor windings for tasks such as filtering current ripples, enhancing power quality during charging. The OEW configuration of the VFMMs (104) may further allow for greater flexibility by allowing independent control of current flow through each terminal of the windings, which may improve fault tolerance, enhance the dynamic performance of the motor, and optimize operation across varying load and power conditions.

In one or more embodiments, the VFMMs (104) may be electrically connected to the battery (108) via a first inverter (112-1). In one or more embodiments, the VFMMs (104) may also be connected to a second inverter (112-2), and the power source (110). In an example, one end of each phase winding from the set of phase windings of the VFMMs (104) may be electrically connected to the first inverter (112-1), which interfaces with the battery (108) to enable bidirectional power flow there between. The opposite end of each phase winding of the VFMMs (104) may be operably connected to either the second inverter (112-2), or with the power source (110). In some embodiments, the dual inverter configuration of unit (100) may allow for smooth transitions between the charging mode and the driving mode. In some embodiments, the windings of the VFMMs 104 may be configured to operate with a single-phase or three-phase electric power supplied from the power source (110).

In one or more embodiments, during the charging mode, the first inverter (112-1) may convert the single-phase or three-phase AC from the power source (110) into the DC, which may be subsequently used to charge the battery (108) via the first inverter (112-1). The second inverter (112-2), while connected to the power source (110), may remain in a passive state, allowing the AC power from the power source (110) to pass through the phase windings of the VFMMs (104). The phase windings of the VFMMs (104), which may be demagnetized to prevent torque generation, may be used as filter inductors to smoothen the AC-to-DC conversion, reducing current ripples, and improving the efficiency of the charging process. Hence, the VFMMs (104) may minimize switching losses and optimize system efficiency during charging.

In one or more embodiments, the power source (110) may be any power outlet capable of providing electric power either in the single-phase or in three-phases. In some embodiments, the power source (110) may be connected to a grid. The form of the electric power supplied by the power source (110) may depend on the distribution or transmission infrastructure associated with the power source (110).

In embodiments where the power source (110) supplies single-phase electric power, the phase windings of the VFMMs (104) may be suitably adapted to receive power therefrom. In some embodiments, unit (100) may include a step-down transformer that lowers voltage of the electric power redirected to the battery (108). In such embodiments, the step-down transformer lowers the voltage of the electric power to a voltage below that of the battery (108). In an example, the battery (108) may have a voltage range of about 350V-400V.

In one or more embodiments, the first inverter (112-1) may draw power from the battery (108) and convert DC into AC to drive the VFMMs (104) in the driving mode. In some embodiments, the second inverter (112-2) may be used to provide higher winding voltage to the VFMMs (104), which may provide a wider operational range for the VFMMs (104) and improve performance thereof. Further, the connection of the VFMMs (104) to both the first inverter (112-1) and the second inverter (112-2) through the OEW configuration may provide greater fault tolerance, as unit (100) can continue to operate even when one of the phases of the VFMMs (104) or the inverters (112-1, 112-2) has failed. In some embodiments, the inverters (112-1, 112-2) may also be used for re-magnetizing the soft magnets in the VFMMs (104) by controllably passing a pulse of electric current through the VFMMs (104).

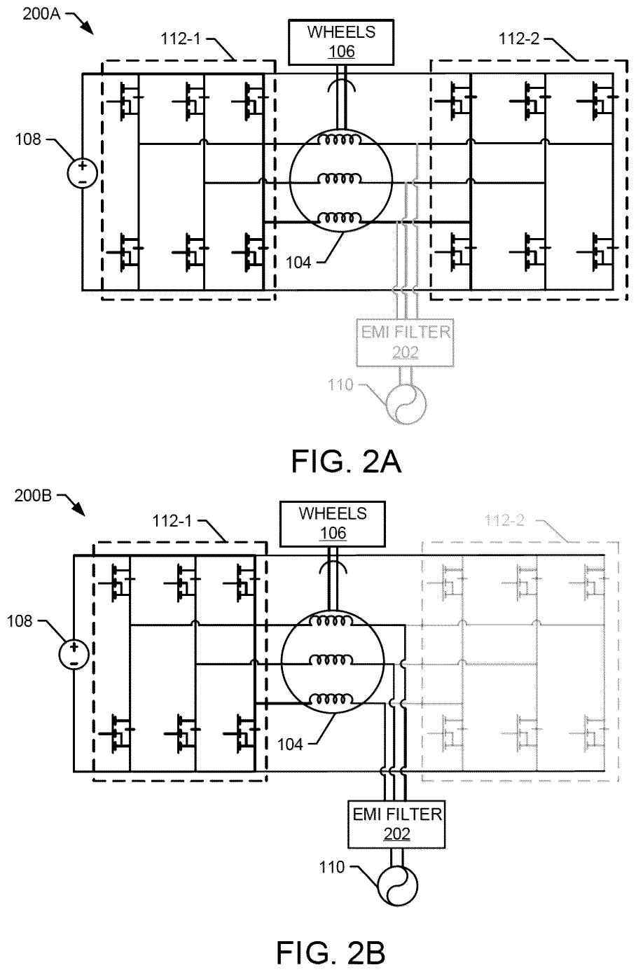

FIG. 2A illustrates a circuit diagram (200A) of integrated unit (100) in the driving mode, according to one or more embodiments. In an example, the circuit utilizes the OEW configuration of the VFMMs (104), to connect the VFMMs (104) with the first inverter (112-1) and the second inverter (112-2). As shown in FIG. 2A, in the driving mode, the VFMMs (104) may be connected to the battery (108) via the first inverter (112-1) on one side of the windings of the VFMMs (104) and the second inverter (112-2) on the other side. In an example, both the first inverter (112-1) and the second inverter (112-2) may collaboratively manage the AC power supplied to the motor windings. The use of two inverters (112-1 and 112-2) increases the voltage that can be provided to the VFMMs (104). The OEW configuration of the VFMMs allows higher motor power at high speeds by applying a higher winding voltage, thereby widening the operational range of the VFMMs (104).

In some embodiments, the first inverter (112-1) converts the DC power from the battery (108) into the required three-phase AC for the motor operation, while the second inverter (112-2) complements this process by enabling dynamic voltage control and balancing across the open-ended windings of the VFMM (104). In an example, the second inverter (112-2) may actively participate in modulating the voltage at the other end of the windings of the VFMMs (104), thereby extending the effective voltage range and allowing the VFMMs (104) to operate at higher speeds or under demanding load conditions. This complementary operation ensures that the VFMMs (104) receives a higher overall winding voltage, improving torque and power output while maintaining efficiency. The dual inverter setup also enables precise control of phase currents and reduces harmonic distortion, enhancing the overall performance and stability of the VFMMs (104).

As shown in FIG. 2A, in some embodiments, the circuit (200A) may also include an electromagnetic interference (“EMI”) filter (202) connected to the power source (110). This EMI filter (202) may be configured to minimize electrical noise and ensure stable operation of the circuit (200A). In the driving mode, the EMI filter (202) is bypassed, as the power is supplied directly from the battery (108) to the VFMM (104) through the inverters (112-1, 112-2).

FIG. 2B illustrates a circuit diagram (200B) of the integrated unit (100) in the charging mode, according to one or more embodiments. In the charging mode, the VFMMs (104) are repurposed as filter inductors to facilitate efficient AC-to-DC conversion for charging the battery (108).

In some embodiments, in the charging mode, the second inverter (112-2) may be deactivated or bypassed, as indicated by faded representation of the second inverter (112-2) in FIG. 2B. The deactivation of the second inverter (112-2) may allow the first inverter (112-1) and the phase windings of the VFMMs (104) to work collaboratively to smoothen the AC input power from the power source (110). In one or more embodiments, the EMI filter (202) may be connected between the power source (110) and the VFMMs (104), to reduce electrical noise and ensure stable input power for the charging process.

In one or more embodiments, the first inverter (112-1) may perform the bidirectional power conversion. During charging, the first inverter (112-1) may convert the AC power from the power source (110) into DC power suitable for charging the battery (108). The phase windings of the VFMMs (104), which may be inductive, act as filter components during this conversion process. By utilizing the inductive characteristics of the windings, the VFMMs (104) may reduce current ripples and harmonics in the AC-to-DC conversion, ensuring smoother and more efficient charging.

In one or more embodiments, the OEW configuration of the VFMMs (104)
may facilitate the charging process by providing a natural separation of the motor windings at both ends. With the second inverter (112-2) inactive, the winding terminals connected to the second inverter (112-2) are isolated, while the terminals connected to the first inverter (112-1) handle the power flow. This configuration enables the VFMMs (104) to act as high-performance passive filter inductors without generating any torque during the charging operation.

In some embodiments, the EMI filter (202), in conjunction with the windings of the VFMMs (104), may ensure stable and low-noise power flow from the power source (110) to the battery (108). The ability of the VFMMs (104) to dynamically switch roles between a torque-generating motor and a filter inductor in the charging mode may reduce the need for additional external filtering components, thereby lowering the system overall cost and complexity.

The integrated unit (100) leverages the dual inverter and OEW VFMM configuration to enable bidirectional power flow. In the charging mode, unit (100) efficiently converts AC power from the power source (110) into DC power for charging the battery (108), while minimizing losses and improving power quality. Unit (100) is also adaptable to accept a wide range of power sources, including single-phase AC, three-phase AC, or DC power, further increasing its versatility for onboard charging applications. Further, in the driving mode, the VFMMs (104) operate using power drawn from the battery (108). The switching components within the inverters (112-1, 112-2) dynamically manage the current flow to the windings of the VFMMs (104), enabling optimal torque generation while maintaining high efficiency. Accordingly, the charger circuit (200A) ensures minimal losses by balancing the voltage and current flow across the windings of the VFMMs (104) and the inverters (112-1, 112-2).

Unit (100) of the present disclosure may, in at least one embodiment, provide enhance performance and/or a widened operational range for the VFMMs (100), while also providing charging capabilities through either single-phase power sources or three-phase power sources-thereby eliminating the need for an additional onboard charger. Further, the present disclosure reduces size, cost, and complexity of the unit (100) by eliminating need for filter inductors-by repurposing the VFMMs (104) for the same and eliminating need for high-current switches to switch between the charging and driving modes. The present disclosure also contemplates and provides fault tolerance and redundancy, by allowing continued operation in the event of a failure in one phase of the VFMMs (104) or inverters (112-1, 112-2).

For the purposes of clarity in this instant patent application, the term “about” is intended to mean approximately or nearly and in the context of a numerical value or range set forth means ±10% of the numeric value. Further, it is known to skilled artisans that term Integrated Charging Unit (“ICU) may be integrated with an Integrated Driving Unit (“IDU”) to form an Integrated Power Electronics Unit (“IPEU”).

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

The invention claimed is:

1. An vehicle having an Integrated Power Electronics Unit (“IPEU) and a battery for storing power from a power source, the IPEU comprising:
at least one synchronous motor having at least two phase windings in Open End Winding
configuration, each winding having at a first and a second end;
at least a first and a second inverter, wherein
the first inverter operably couples with the first end of each of the at least two
phase windings, and operably configures bidirectional power flow between the
battery and the at least one synchronous motor; and
the second inverter operably couples with the second end of each of the at least
phase windings and the power source; and
wherein the at least one synchronous motor is operably configured as a filter inductor between the power source and the first inverter in a charging mode.

2. The vehicle of claim 1, wherein the IPEU comprises at least a charging mode and a driving mode, and wherein:
in the charging mode, the at least one synchronous motor is operably configured to allow
power to flow between the power source and the battery; and
in the driving mode, the battery is operably configured to allow power to flow to the at
least one synchronous motor.

3. The vehicle of claim 2, wherein the at least one voltage comprises a winding voltage from the first inverter and the second inverter.

4. The vehicle of claim 3, wherein the at least one synchronous motor being operably configured to generate torque on corresponding with at least one voltage from the second inverter in a driving mode.

5. The vehicle of claim 4, wherein the second inverter operably modulates the at least one voltage across the at least two phase windings of the at least one synchronous motor.

6. The vehicle of claim 5, wherein the IPEU operably shifts between charging mode and driving mode according to a magnetization state of the at least one synchronous motor.

7. The vehicle of claim 6, wherein the at least one synchronous motor comprises at least one rotor magnet having a magnetization operably adjusted by passing a pulse to magnetized or de-magnetized the at least rotor magnet.

8. The vehicle of claim 7, wherein the at least one synchronous motor comprises at least one soft-ferromagnetic material, and a magnetization state of the at least soft ferromagnetic material operably adjustable by a pulse of electric current to enable dynamic torque control.

9. The vehicle of claim 8, wherein the at least one synchronous motor comprises at least one of a Variable Flux Memory Motor (VFMM) or a Wound Field Synchronous Motor (“WFSM”).

10. The vehicle of claim 9, further comprising a step-down transformer that operably lowers the power flow to the battery.

11. An Integrated Power Electronics Unit (“IPEU) having a battery for storing power from a power source, the IPEU comprising:
at least one VFMM having at least two phase windings in Open End Winding configuration, each winding having at a first and a second end;
at least a first and a second inverter, wherein
the first inverter operably couples with the first end of each of the at least two
phase windings, and operably configures bidirectional power flow between the
battery and the at least one VFMM; and
the second inverter operably couples with the second end of each of the at least
phase windings and the power source;
wherein the at least one VFMM is operably configured as a filter inductor between the
power source and the first inverter in a charging mode; and
wherein the IPEU comprises at least a charging mode and a driving mode such that in the charging mode, the at least one VFMM is operably configured to allow power to flow between the power source and the battery; and
in the driving mode, the battery is operably configured to allow power to flow to
the at least one VFMM.

12. The IPEU of claim 11, wherein the at least VFMM being operably configured to generate torque on corresponding with at least one voltage from the second inverter in a driving mode.

13. The IPEU of claim 12, wherein the at least one voltage comprises a winding voltage from the first inverter and the second inverter.

14. The IPEU of claim 13, wherein the second inverter operably modulates the at least one voltage across the at least two phase windings of the at least one VFMM.

15. The IPEU of claim 14, wherein electrical connections between the second end and the power source are operably activated and electrical connections between the second end and the second inverter are operably deactivated in the charging mode.

16. The IPEU of claim 15, wherein the at least one VFMM comprises at least one rotor magnet having a magnetization operably adjusted by passing a pulse to magnetized or de-magnetized the at least rotor magnet.

17. The IPEU of claim 11, wherein the first inverter is operably configured to convert at least one of: a single-phase or three-phase alternating current (AC) from the power source into direct current (DC) to charge the battery.

18. The IPEU of claim 11, further comprising an electromagnetic interference (EMI) filter positioned between the power source and the at least one VFMM, wherein the EMI filter is operably configured to reduce electrical noise in the integrated charging and driving unit in the charging mode.

19. The IPEU of claim 11, wherein the battery is operably configured to store electric power from the power source during the charging mode, and supply electric power to the at least one synchronous motor through the first and second inverters during the driving mode.

20. The IPEU of claim 11, wherein the second inverter is operably configured to supplement winding voltage provided to the at least one VFMM during the driving mode.
